(19) United States
(12) Patent Application Publication
(10) Pub. No.: US 2012/0319510 A1
(43) Pub. Date: Dec. 20, 2012

(54) STATOR ASSEMBLY FOR MOTOR AND MOTOR INCLUDING THE SAME

(75) Inventors: Jong Ryeol Oh, Seoul (KR); Ho Kyung Jang, Suwon (KR); Sang Jin Park, Hwaseong (KR)

(73) Assignee: SAMSUNG ELECTRO-MECHANICS CO., LTD., Suwon (KR)

(21) Appl. No.: 13/439,448

(22) Filed: Apr. 4, 2012

(30) Foreign Application Priority Data
Jun. 20, 2011 (KR) 10-2011-0059549

(51) Int. Cl. H02K 5/24

(52) U.S. Cl. 310/51

(57) ABSTRACT

There is provided a stator assembly for a motor, the stator assembly including: a base including a core mounted therein, the core having a coil wound therearound and the coil generating rotational driving force of a rotating member; and an absorbing part coupled to the base so as to be disposed on an upper surface of the core and absorbing vibrations or noise of the core.

### CROSS-REFERENCE TO RELATED APPLICATIONS

This application claims the priority of Korean Patent Application No. 10-2011-0059549 filed on Jun. 20, 2011, in the Korean Intellectual Property Office, the disclosure of which is incorporated herein by reference.

### BACKGROUND OF THE INVENTION

1. Field of the Invention

The present invention relates to a stator assembly for a motor and a motor including the same, and more particularly, to a motor capable of being used in a hard disk drive (HDD) for rotating a recording disk.

2. Description of the Related Art

A hard disk drive (HDD), an information storage device, reads data stored in a disk or writes data to the disk using a read/write head.

The hard disk drive requires a disk driving device capable of driving the disk. As the disk driving device, a small-sized spindle motor is used.

In the small-sized spindle motor, a fluid dynamic pressure bearing has been used. The fluid dynamic pressure bearing refers to a bearing in which a shaft, a rotating member, and a sleeve, a fixed member, have oil interposed therebetween, such that the shaft is supported by fluid pressure generated by the oil.

The hard disk drive (HDD) using this fluid dynamic pressure bearing has been used in various portable products such as a netbook, a cellular phone, a portable multimedia player (PMP), a video game machine, a MP3 player, and the like. Interest in the necessity of the miniaturization and thinning of the hard disk drive has increased in consideration of portable products.

In addition, as cases in which users carry the hard disk drive (HDD) using the fluid dynamic pressure bearing increase, whether or not noise and vibrations are generated in the spindle motor using the fluid dynamic pressure bearing has become a significantly sensitive issue.

The noise and vibrations may be generated due to shaking, or the like, of a core around which a coil is wound. The shaking, or the like, of the core is in close association with parallelism of the core.

That is, research into a technology for maintaining firm coupling force simultaneously with maintaining parallelism of a core in the case of combining the core with a base to thereby prevent noise and vibrations due to shaking, or the like, of the core has been urgently required.

### SUMMARY OF THE INVENTION

An aspect of the present invention provides a stator assembly for a motor maintaining parallelism of a core to prevent shaking thereof, thereby minimizing the generation of noise and vibrations, and a motor including the same.

According to an aspect of the present invention, there is provided a stator assembly for a motor, the stator assembly including: a base including a core mounted therein, the core having a coil wound therearound, the coil generating rotational driving force of a rotating member; and an absorbing part coupled to the base so as to be disposed on an upper surface of the core and absorbing vibrations or noise of the core.

The base may include a fixing groove having one end of the absorbing part inserted thereinto so that the absorbing part is fixed thereto.

The core may include a core groove having the other end of the absorbing part inserted thereinto so that the absorbing part is fixed thereto.

The absorbing part may include a base coupling part coupled to the base, and a core supporting part supporting the upper surface of the core.

A surface of the core supporting part contacting the core may be inclined downwardly in an outer diameter direction to thereby press the upper surface of the core.

The absorbing part may be continuously formed along the upper surface of the core in a circumferential direction.

The absorbing part may be made of a rubber material having elasticity.

The absorbing part may be a spring having elasticity.

According to another aspect of the present invention, there is provided a motor including: the stator assembly as described above; a sleeve coupled to the base and supporting a shaft; and a hub coupled to the shaft and having a magnet coupled thereto, the magnet generating rotational driving force by interaction with the coil.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a cross-sectional view schematically showing a motor including a stator assembly according to an embodiment of the present invention;

FIG. 2 is an exploded perspective view schematically showing a stator assembly for a motor according to an embodiment of the present invention;

FIG. 3 is a perspective view schematically showing an absorbing part provided in a stator assembly for a motor according to an embodiment of the present invention;

FIG. 4 is a perspective view schematically showing a modified example of an absorbing part provided in a stator assembly for a motor according to an embodiment of the present invention;

FIG. 5 is a perspective view schematically showing another modified example of an absorbing part provided in a stator assembly for a motor according to an embodiment of the present invention; and

FIG. 6 is a perspective view schematically showing another modified example of an absorbing part provided in a stator assembly for a motor according to an embodiment of the present invention.

### DETAILED DESCRIPTION OF THE PREFERRED EMBODIMENT

Exemplary embodiments of the present invention will now be described in detail with reference to the accompanying drawings. The invention may, however, be embodied in many different forms and should not be construed as being limited to the embodiments set forth herein. Rather, these embodiments are provided so that this disclosure will be thorough and complete, and will fully convey the scope of the invention to those skilled in the art.

In the drawings, the same reference numerals will be used throughout to designate the same or like elements.

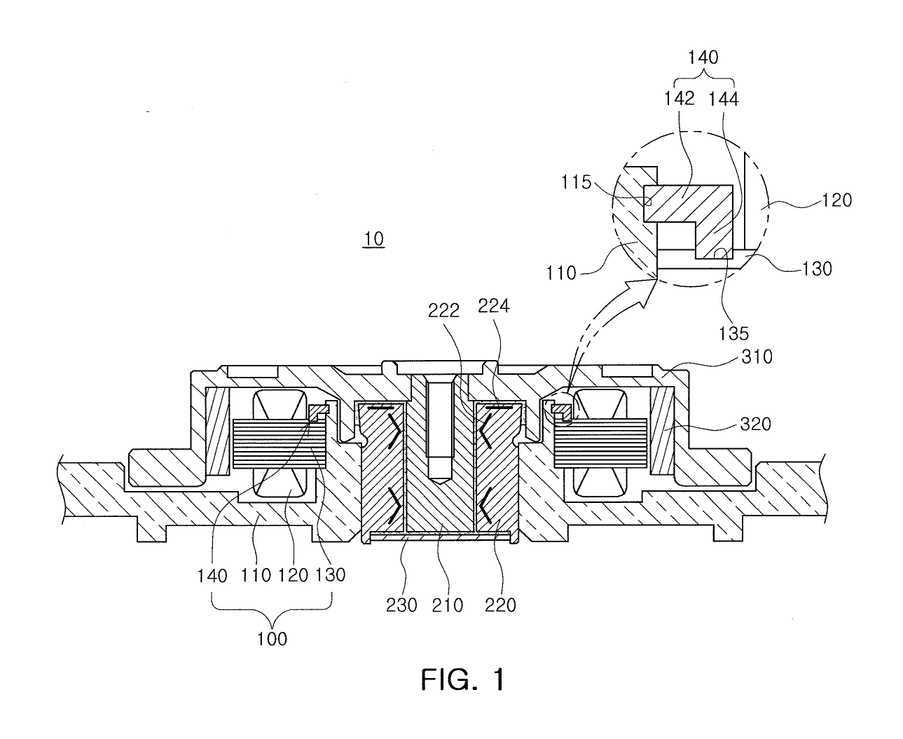

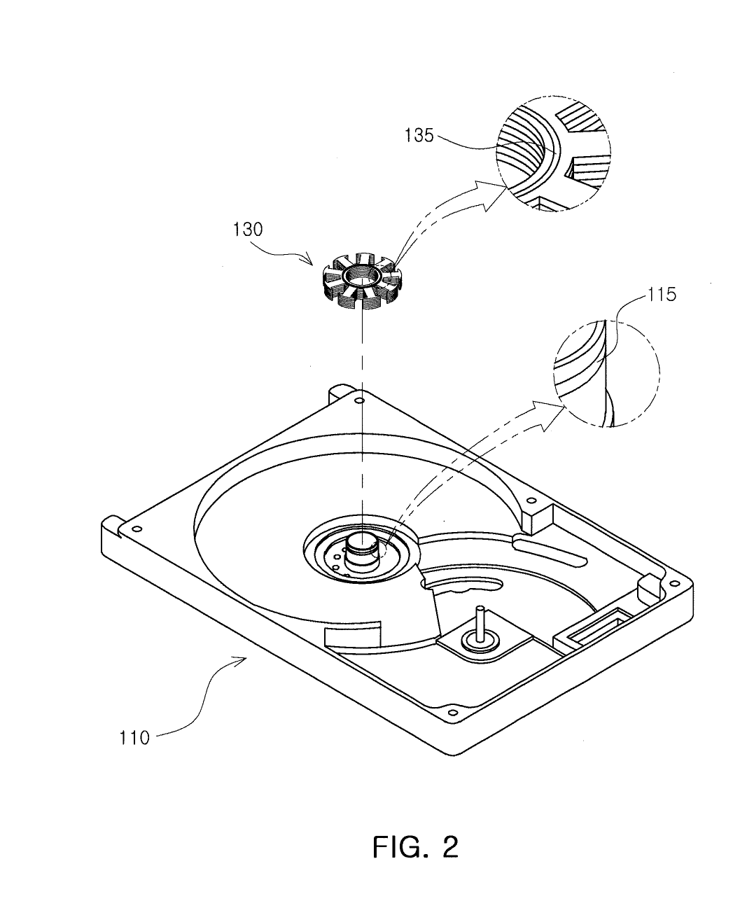

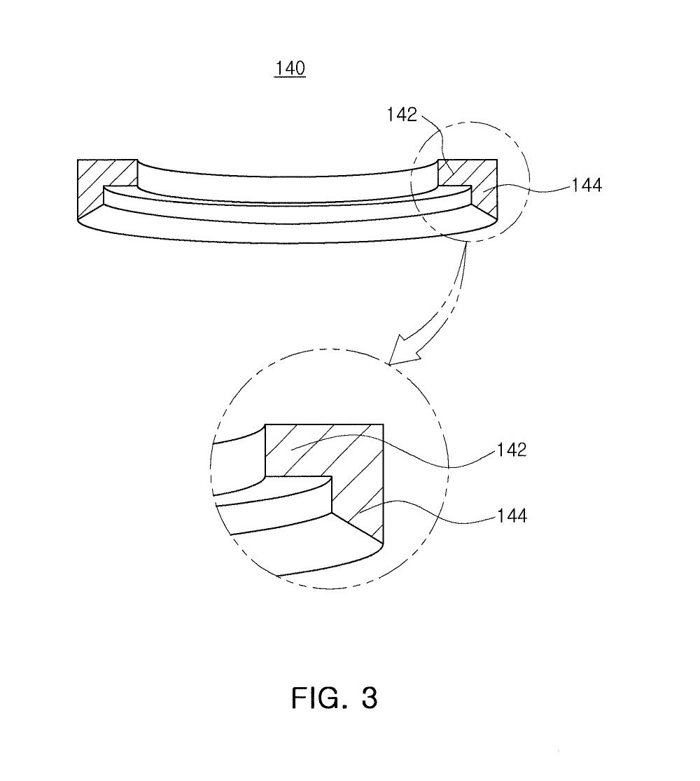

FIG. 1 is a cross-sectional view schematically showing a motor including a stator assembly for a motor according to an embodiment of the present invention; FIG. 2 is an exploded perspective view schematically showing a stator assembly for a motor according to an embodiment of the present invention; FIG. 3 is a perspective view schematically showing an absorbing part provided in a stator assembly for a motor according to an embodiment of the present invention.

Referring to FIGS. 1 through 3, a motor 10 according to an embodiment of the present invention may include a stator assembly 100 for a motor (hereinafter, referred to as a stator assembly) including a base 110 and an absorbing part 140, a sleeve 220 supporting a shaft 210, and a hub 310 having a magnet 320 coupled thereto.

Terms with respect to directions will be first defined. As viewed in FIG. 1, an axial direction refers to a vertical direction based on the shaft 210, and an outer diameter or inner diameter direction refers to a direction towards an outer edge of the hub 310 based on the shaft 210 or a direction towards the center of the shaft 210 based on the outer edge of the hub 310.

In addition, a circumferential direction refers to a direction in which the shaft 210 rotates along an outer peripheral surface thereof.

The stator assembly 100 may include the base 110 having a core 130 mounted thereon and the absorbing part 140 absorbing vibrations or noise, in which the core 130 has a coil 120 wound therearound. A description of the base 110 and the absorbing part 140 will be provided after other components of the motor 10 according to the embodiment of the present invention are described.

The sleeve 220 may support the shaft 210 such that an upper end of the shaft 210 protrudes upwardly in the axial direction, and may be formed by forging Cu or Al or sintering Cu—Fe based alloy powder or SUS based power.

Here, the shaft 210 is inserted into a shaft hole of the sleeve 220, having a micro clearance therebetween. The micro clearance is filled with oil, and the rotation of the shaft 210 may be more stably supported by a fluid dynamic pressure part 222 formed in at least one of an outer peripheral surface of the shaft 210 and an inner peripheral surface of the sleeve 220.

The fluid dynamic pressure part 222 may generate radial dynamic pressure via the oil and may be formed in each of upper and lower portions of the sleeve 220 in order to more effectively support the shaft 210 by the radial dynamic pressure.

However, the fluid dynamic pressure part 222 may also be formed in the outer peripheral surface of the shaft 210 as well as in the inner peripheral surface of the sleeve 220 as described above. In addition, the number of the fluid dynamic pressure parts 222 is not limited.

Here, the fluid dynamic pressure part 222 may be a groove having a herringbone shape, a spiral shape, or a screw shape. However, the fluid dynamic pressure part 222 is not limited to having the above-mentioned shape but may have any shape as long as radial dynamic pressure may be generated by the rotation of the shaft 210.

In addition, the sleeve 220 may have a thrust dynamic pressure part 224 formed in the upper surface thereof, the thrust dynamic pressure part 224 generating thrust dynamic pressure via the oil. A rotating member including the shaft 210 may rotate in a state in which a predetermined floating force is secured by the thrust dynamic pressure part 224.

Here, the thrust dynamic pressure part 224 may be a groove having a herringbone shape, a spiral shape, or a screw shape, similar to the fluid dynamic pressure part 222. However, the thrust dynamic pressure part 224 is not limited to having the above-mentioned shape but may have any shape as long as thrust dynamic pressure may be provided.

In addition, the thrust dynamic pressure part 224 is not limited to being formed in the upper surface of the sleeve 220 but may also be formed in a surface of the hub 310 corresponding to the upper surface of the sleeve 220.

In addition, the sleeve 220 has a base cover 230 coupled to the lower portion thereof, such that the base cover 230 closes the lower portion of the sleeve 220. The motor 10 according to the embodiment of the present invention may be formed in a full-fill structure by the base cover 230.

The hub 310 may be a rotating structure rotatably provided with respect to the fixed member including the base 110.

In addition, the hub 310 may include the annular ring shaped magnet 320 provided on an inner peripheral surface thereof, the annular ring shaped magnet 320 corresponding to the core 130 while having a predetermined interval therebetween.

Here, the magnet 320 interacts with the coil 120 wound around the core 130, whereby the motor 10 according to the embodiment of the present invention may obtain rotational driving force.

The stator assembly 100 may include the base 110 and the absorbing part 140, and the base 110 may be a fixed member supporting the rotation of the rotating member including the shaft 210 and the hub 310.

Here, the base 110 may be coupled to the core 130 having the coil 120 wound therearound. The core 130 may be fixedly disposed on an upper portion of the base 110 including a printed circuit board (not shown) having a circuit pattern printed thereon.

In other words, the base 110 may have the outer peripheral surface of the sleeve 220 and the core 130 having the coil 120 wound therearound inserted thereinto, such that the sleeve 220 and the core 130 are coupled thereto.

Here, as a method of coupling the sleeve 220 and the core 130 to the base 110, a bonding method, a welding method, a press-fitting method, or the like, may be used. However, a method of coupling the sleeve 220 and the core 130 to the base 110 is not necessarily limited thereto.

The absorbing part 140 may be coupled to the base 110 so as to be disposed on an upper surface of the core 130, and the base 110 may include a fixing groove 115 formed therein for coupling the absorbing part 140 thereto.

The absorbing part 140 may functionally maintain parallelism of the core 130 to thereby improve unmating force of the core 130 and absorb noise or vibrations caused by the shaking, or the like, of the core 130.

Therefore, the absorbing part 140 may be made of a rubber material having elasticity.

In addition, the absorbing part 140 may have one end inserted into the fixing groove 115 of the base 110 to thereby be fixed thereto and the other end disposed on the upper surface of the core 130 to thereby press the upper surface of the core 130.

Here, the upper surface of the core 130 may include a core groove 135 so that the other end of the absorbing part 140 is inserted thereinto to thereby press the core 130. However, the upper surface of the core 130 may be pressed by the absorbing part 140 without the core groove 135.

A specific configuration of the absorbing part 140 will be described. The absorbing part 140 may be continuously formed along the upper surface of the core 130 in the circumferential direction.

Therefore, the fixing groove 115 and the core groove 135 may also be continuously formed in the circumferential direction so as to correspond to the absorbing part 140.

In addition, the absorbing part 140 may include a base coupling part 142 inserted into the fixing groove 115 of the base 110 to thereby be fixed thereto and a core supporting part 144 bent from an end portion of the base coupling part 142.

The core supporting part 144 may support the core 130 by pressing the upper surface of the core 130. In order to maximize supporting force of the core 130, the core supporting part 144 may be formed such that one surface thereof contacting the core 130 is inclined downwardly in the outer diameter direction.

That is, one surface of the core supporting part 144 contacting the upper surface of the core 130 is inclined, whereby force exerted on the core 130 may be maximized.

In addition, the absorbing part 140 may stably support the core 130 without an adhesive by the force exerted on the core 130 generated by elastic deformation of the core supporting part 144.

Therefore, the absorbing part 140 supports the core 130, whereby the parallelism of the core 130 may be maintained and a source of vibrations and noise due to a lack of parallelism in the core 130 may be minimized.

In addition, since the absorbing part 140 may maximize the unmating force of the core 130, that is, coupling force between the core 130 and the base 110, it may minimize a possibility that the core 130 will separate from the base 110 due to external impacts, or the like.

Additionally, an end portion of the core supporting part 144 of the absorbing part 140 may be inserted into the core groove 135 formed in the upper surface of the core 130 to thereby be more stably fixed thereto.

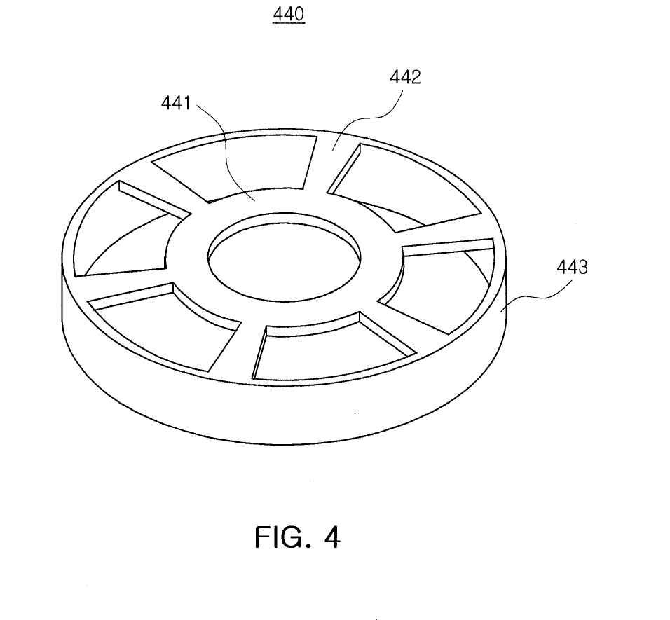

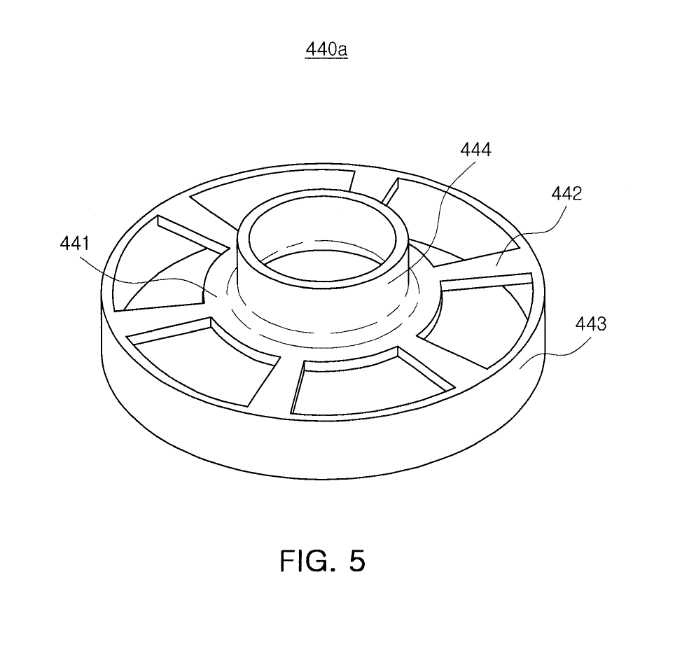

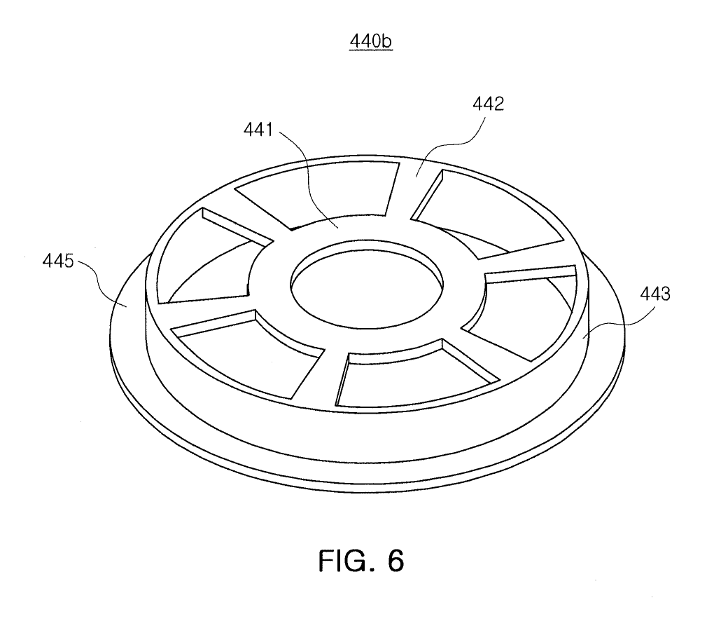

FIG. 4 is a perspective view schematically showing a modified example of an absorbing part provided in a stator assembly for a motor according to an embodiment of the present invention; FIG. 5 is a perspective view schematically showing another modified example of an absorbing part provided in a stator assembly for a motor according to an embodiment of the present invention; and FIG. 6 is a perspective view schematically showing another modified example of an absorbing part provided in a stator assembly for a motor according to an embodiment of the present invention.

Referring to FIGS. 4 through 6, an absorbing part 440, 440a, or 440b provided in the stator assembly 100 for a motor according to the embodiment of the present invention may be a spring having elasticity. The absorbing part 440, 440a, or 440b has been slightly exaggerated in FIGS. 4 through 6 in order to provide a visual effect.

Here, the spring, which is the absorbing part 440, 440a, or 440b, is a component capable of absorbing noise or vibrations, similar to a rubber material, and may maintain parallelism of the core 130 while simultaneously supporting the upper surface of the core 130 to thereby suppress generation of the noise and vibrations.

Referring to FIG. 4, the spring, which is the absorbing part 440, may include an elastic fixing part 441, an elastic leg 442, and an elastic supporting part 443.

The elastic fixing part 441 may be inserted into the fixing groove 115 formed in the base 110 to entirely fix the absorbing part 440, and the elastic supporting part 443 may be inserted into the core groove 135 formed in the upper surface of the core 130 to thereby support the core 130.

Here, the elastic leg 442, which is a component connecting the elastic fixing part 441 and the elastic supporting part 443 to each other, may be a source providing elastic force of the absorbing part 440.

A plurality of elastic legs 442 may be formed to be spaced apart from each other as shown in FIG. 4. Alternatively, the elastic leg 442 may be continuously formed.

In addition, the elastic supporting part 443 may press directly the upper surface of the core 130. In this case, the core groove 135 may not be formed.

Referring to FIG. 5, the spring, which is the absorbing part 440a, may further include an extension part 444.

Here, the extension part 444 may be extended upwardly from an end portion of the elastic fixing part 441 in the axial direction and may be inserted into the base 110 to thereby entirely fix the absorbing part 440a.

That is, due to the extension part 444, the fixing groove 115 may not be formed in the base 110.

Referring to FIG. 6, the spring, which is the absorbing part 440b, may further include a pressing part 445.

Here, the pressing part 445 may be extended from an end portion of the elastic supporting part 443 in the outer diameter direction and may contact the upper surface of the core 130.

Therefore, the core 130 may be supported by the pressing part 445. In this case, the core groove 135 may not be formed in the core 130.

In the motor 10 according to the embodiment of the present invention, when the core 130 is coupled to the base 10, the parallelism of the core 130 may be maintained by the absorbing part 140, 440, 440a, and 440b. Therefore, the generation of noise and vibrations due to the shaking, or the like, of the core 130 may be minimized.

In addition, even when noise and vibrations are generated due to the shaking, or the like, of the core 130, they are absorbed by the absorbing part 140, 440, 440a, and 440b, whereby the performance of the motor 10 according to the embodiment of the present may be improved.

Further, the unmating force of the core 130 is improved, whereby the separation of the core 130 from the base 110 due to external impacts, or the like, may be prevented.

As set forth above, in the case of a stator assembly for a motor and a motor including the same according to embodiments of the present invention, when a core is coupled to a base, unmating force may be improved while the parallelism of the core may be maintained.

In addition, the parallelism of the core is maintained, whereby the generation of noise and vibrations due to shaking, or the like, of the core may be minimized.

While the present invention has been shown and described in connection with the above embodiments, it will be apparent to those skilled in the art that modifications and variations can be made without departing from the spirit and scope of the invention as defined by the appended claims.

What is claimed is:

1. A stator assembly for a motor, the stator assembly comprising:
a base including a core mounted therein, the core having a coil wound therearound, the coil generating rotational driving force of a rotating member; and
an absorbing part coupled to the base so as to be disposed on an upper surface of the core and absorbing vibrations or noise of the core.

2. The stator assembly of claim 1, wherein the base includes a fixing groove having one end of the absorbing part inserted thereinto so that the absorbing part is fixed thereto.

3. The stator assembly of claim 1, wherein the core includes a core groove having the other end of the absorbing part inserted thereinto so that the absorbing part is fixed thereto.

4. The stator assembly of claim 1, wherein the absorbing part includes:
a base coupling part coupled to the base; and
a core supporting part supporting the upper surface of the core.

5. The stator assembly of claim 4, wherein a surface of the core supporting part contacting the core is inclined downwardly in an outer diameter direction to thereby press the upper surface of the core.

6. The stator assembly of claim 1, wherein the absorbing part is continuously formed along the upper surface of the core in a circumferential direction.

7. The stator assembly of claim 1, wherein the absorbing part is made of a rubber material having elasticity.

8. The stator assembly of claim 1, wherein the absorbing part is a spring having elasticity

9. A motor comprising:
the stator assembly of claim 1;
a sleeve coupled to the base and supporting a shaft; and
a hub coupled to the shaft and having a magnet coupled thereto, the magnet generating rotational driving force by interaction with the coil.
